(19) United States
(12) Patent Application Publication
(10) Pub. No.: US 2024/0077124 A1
(43) Pub. Date: Mar. 7, 2024

(54) NON-METAL SPRING

(71) Applicant: MAGNETIC PACKAGING INC., TAICHUNG CITY (TW)

(72) Inventors: CHIH-CHUNG SUN, TAICHUNG CITY (TW); KAI-HSIANG CHANG, TAICHUNG CITY (TW)

(21) Appl. No.: 17/939,930

(22) Filed: Sep. 7, 2022

(51) Int. Cl. F16F 1/36

(52) U.S. Cl. CPC F16F 1/3605

(57) ABSTRACT

A non-metal spring includes two non-metal elastic units connected to each other and formed between two non-metal terminal rings. Each of the non-metal elastic units includes two intermediate rings intersecting each other, thereby providing two cross portions. The cross portions of each of the non-metal elastic units divide each of the intermediate rings into a first portion and a second portion. The first portions of the intermediate rings of one of the non-metal elastic units are connected to one of the terminal rings. The second portions of the intermediate rings of another one of the non-metal elastic units are connected to a remaining one of the terminal rings. The first portions of the intermediate rings of each of the non-metal elastic units are connected to the second portions of the intermediate rings of an adjacent one of the non-metal elastic units.

### BACKGROUND OF INVENTION

### 1. Field of Invention

The present invention relates to a spring and, more particularly, to a non-metal spring.

### 2. Related Prior Art

There are various springs. A spring is often made of a metal string or a metal strip. A spring made of a metal string can be a helical spring, a coil spring or a torque spring. A spring made of a metal strip can be a leaf spring, a coil spring or a Belleville spring.

The Belleville spring includes a stack of alternately arranged conical dishes. The conical dishes expand transversely when the Belleville spring is subjected to a compressing forcing. The conical dishes recover when the Belleville spring is released from the compressing force. However, the conical dishes tend to slide transversely relative to one another when the Belleville spring is compressed between two objects. Hence, the Belleville spring cannot effectively operate between the objects.

Moreover, the conical dishes are made of metal in a complicated process that includes punching and finishing for example. Hence, the cost of the Belleville spring is high.

The present invention is therefore intended to obviate or at least alleviate the problems encountered in the prior art.

### SUMMARY OF INVENTION

It is the primary objective of the present invention to provide an inexpensive non-metal spring.

To achieve the foregoing objective, the non-metal spring includes two non-metal intermediate rings formed between two non-metal terminal rings. The non-metal intermediate rings intersect each other, thereby providing two cross portions.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a non-metal spring according to the preferred embodiment of the present invention;

FIG. 2 is a cross-sectional view of the non-metal spring depicted in FIG. 1;

FIG. 3 is a cross-sectional view of the non-metal spring taken along a line A-A shown in FIG. 2;

FIG. 4 is a cross-sectional view of the non-metal spring taken along a line B-B shown in FIG. 2; and

FIGS. 5 and 6 are two cross-sectional views of the non-metal spring shown in FIG. 1 in two positions in operation.

### DETAILED DESCRIPTION OF PREFERRED EMBODIMENT

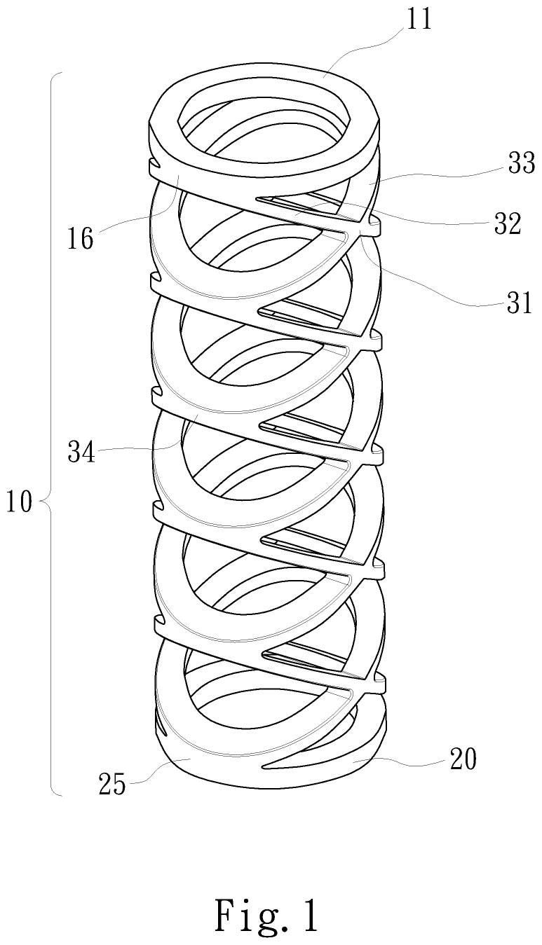

Referring to FIGS. 1 through 3, there is a non-metal spring 10 according to the preferred embodiment of the present invention. The non-metal spring 10 is made of a plastic material or a polymer by injection molding for example.

The non-metal spring 10 extends along a rectilinear axis (or “length”). The non-metal spring 10 includes multiple elastic units 30 formed between two terminal rings 11 and 20 along the axis. The elastic units 30 are annular. Thus, the non-metal spring 10 includes a tunnel (not numbered) through the terminal rings 11 and 20 and the elastic units 30 along the axis. Preferably, the terminal rings 11 and 20 and the elastic units 30 are made in one piece. Preferably, there are five (5) elastic units 30 between the terminal rings 11 and 20. However, there can be only one elastic unit 30 between the terminal rings 11 and 20.

Preferably, the terminal rings 11 and 20 are like each other in shape and size. The terminal ring 11 includes an internal face 12, an external face 13, an upper face 14, and a lower face 15. The internal and external faces 12 and 13 are formed between the upper and lower faces 14 and 15. Similarly, the terminal ring 20 includes an internal face 21, an external face 22, an upper face 23, and a lower face 24.

Each of the elastic units 30 includes two intermediate rings 32 and 33 intersecting each other, thereby forming two cross portions 31. That is, the intermediate rings 32 and 33 together form a X-shaped structure with a height 45.

The cross portions 31 divide the intermediate ring 32 into an upper portion 32a and a lower portion 32b. Similarly, the cross portions 31 divide the intermediate ring 33 into an upper portion 33a and a lower portion 33b. The upper portions 32a and 33a are movable relative to the lower portions 32b and 33b.

There is an obtuse angle 35 between the upper portion 32a of the ring 32 and the upper portion 33a of the ring 33. There is another obtuse angle 35 between the lower portion 32b of the intermediate ring 32 and the lower portion 33b of the intermediate ring 33. There is an acute angle 36 between the upper portion 32a of the ring 32 and the lower portion 33b of the ring 33. There is another acute angle 36 between the upper portion 33a of the ring 33 and the lower portion 32b of the ring 32. Each of the obtuse angles 35 is complementary with each of the acute angles 36.

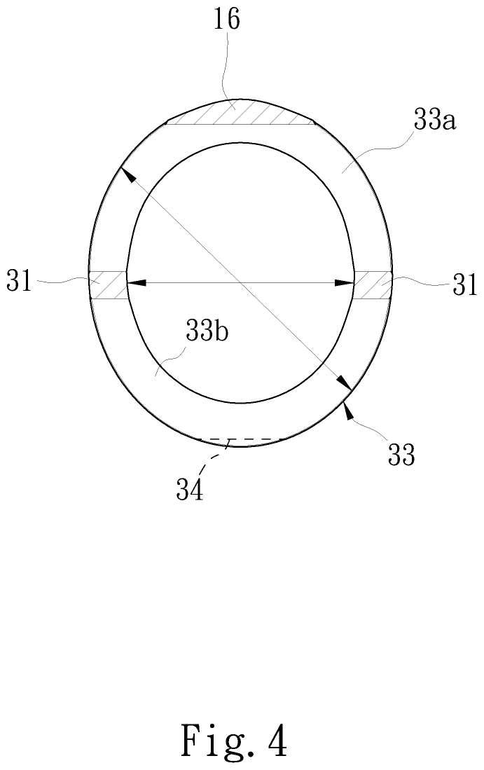

Preferably, the terminal rings 11 and 20 are circular rings. Accordingly, the intermediate rings 32 and 33 are oval rings (FIG. 4).

For clarity of the following description, the elastic units 30 will be referred to as the first, second, third, fourth and fifth elastic units 30 from top to bottom.

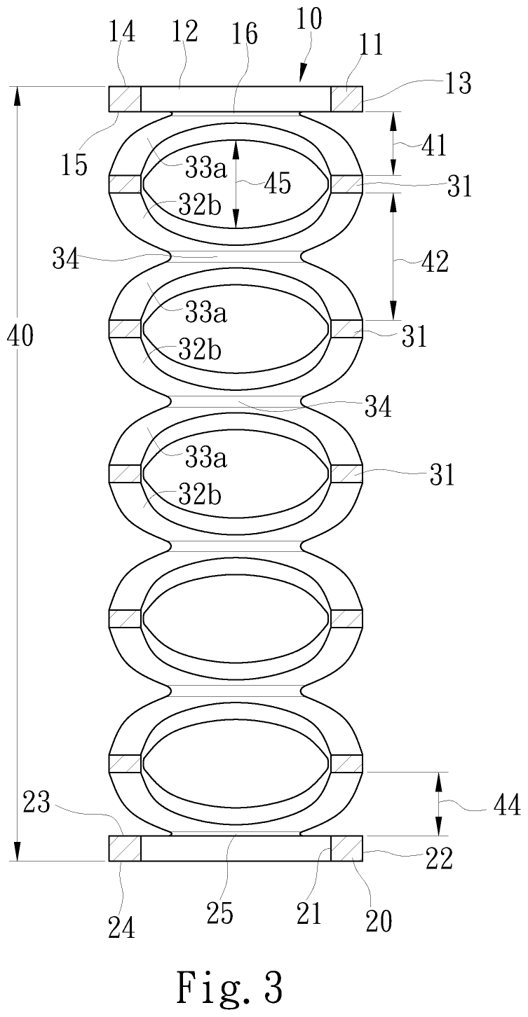

The upper portion 32a of the intermediate ring 32 of the first elastic unit 30 is connected to the lower face 15 of the terminal ring 11, thereby forming a connective portion 16. Similarly, the upper portion 33a of the intermediate ring 33 of the first elastic unit 30 is connected to the lower face 15 of the terminal ring 11, thereby forming another connective portion 16. The upper portions 32a and 33a of the intermediate rings 32 and 33 of the first elastic unit 30 and the terminal ring 11 together form a triangular structure. The lower face 15 of the terminal ring 11 is at a distance 41 from the cross portions 31 of the first elastic unit 30 (FIG. 3).

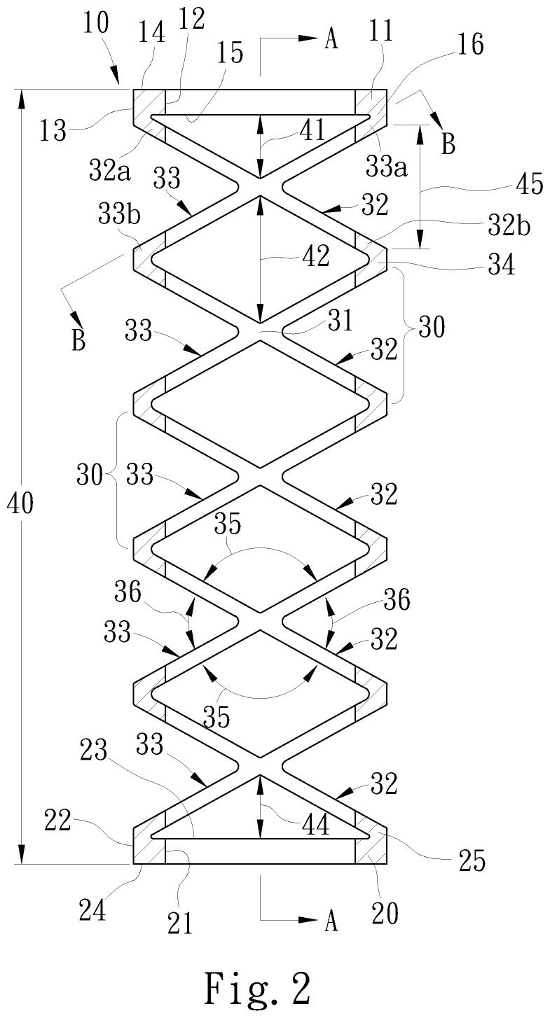

The upper portion 32a of the intermediate ring 32 of the second elastic unit 30 is connected to the lower portion 33b of the intermediate ring 33 of the first elastic unit 30, there by forming a connective portion 34. The upper portion 33a of the intermediate ring 33 of the second elastic unit 30 is connected to the lower portion 32b of the intermediate ring 32 of the first elastic unit 30, thereby providing another connective portion 34. Thus, the second elastic unit 30 is connected to the first elastic unit 30. The upper portions 32a and 33a of the intermediate rings 32 and 33 of the second elastic unit 30 and the lower portions 32b and 33b of the intermediate rings 32 and 33 of the first elastic unit 30 together form a diamond-shaped structure (FIG. 2). The diamond-shaped structure is made with a height identical to a distance 42 between each of the cross portion 31 of the second elastic unit 30 and a corresponding one of the cross portions 31 of the first elastic unit 30 (FIG. 3).

Similarly, the third elastic unit 30 is connected to the second elastic unit 30. There is another distance 42 between each of the cross portion 31 of the third elastic unit 30 and a corresponding one of the cross portions 31 of the second elastic unit 30 (FIG. 3).

Similarly, the fourth elastic unit 30 is connected to the third elastic unit 30. There is another distance 42 between each of the cross portion 31 of the fourth elastic unit 30 and a corresponding one of the cross portions 31 of the third elastic unit 30 (FIG. 3).

Similarly, the fifth elastic unit 30 is connected to the fourth elastic unit 30. There is another distance 42 between each of the cross portion 31 of the fifth elastic unit 30 and a corresponding one of the cross portions 31 of the fourth elastic unit 30 (FIG. 3).

The upper face 23 of the terminal ring 20 is connected to the lower portions 32b and 33b of the intermediate rings 32 and 33 of the fifth elastic unit 30, thereby forming two connective portions 25. The terminal ring 20 and the lower portions 32b and 33b of the intermediate rings 32 and 33 of the fifth elastic unit 30 together form a triangular structure. There is a distance 44 between the upper face 23 of the terminal ring 20 and each of the cross portions 31 of the fifth elastic unit 30.

The non-metal spring 10 includes five (5) cross portions 31 on each of two opposite sides. The non-metal spring 10 includes one connective portion 16, one connective portion 25 and four (4) connective portions 34 on each of two other opposite sides. The elastic units 30 keep the terminal ring 11 above the terminal ring 20, thereby keeping the non-metal spring 10 at a total height (or “length”) 40 measured from the upper face 14 of the terminal ring 11 to the lower face 24 of the terminal ring 20.

When the non-metal spring 10 is subjected to a compressing force, the total height 40 is reduced. That is, the distances 41, 42 and 44 are reduced, and so are the heights 45. When the non-metal spring 10 is released from the compressing force, the total height 40 is recovered. That is, the distances 41, 42 and 44 are recovered, and so are the heights 45.

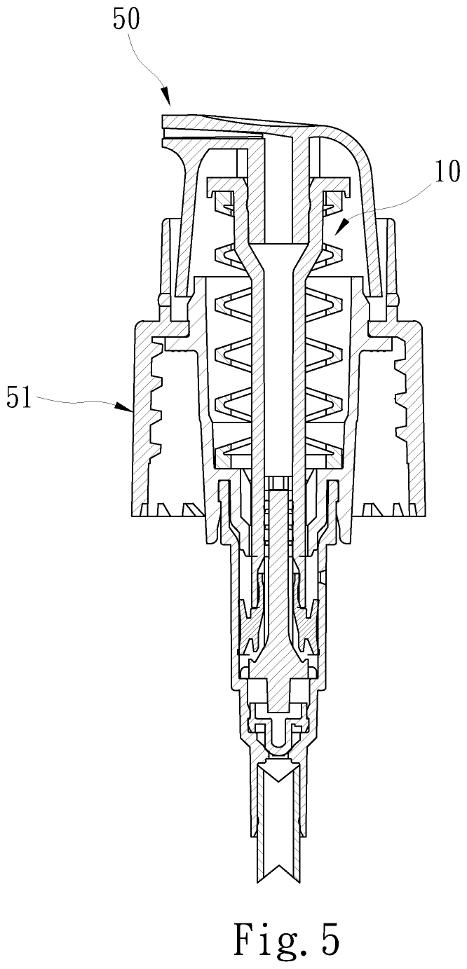

Referring to FIG. 5, the non-metal spring 10 is arranged between a button 50 and a threaded cup 51. The non-metal spring 10 is compressed when the button 50 is subjected to a pushing force, i.e., moved toward the threaded cup 51. The axis of the non-metal spring 10 stays rectilinear during the compression of the non-metal spring 10. That is, the terminal rings 11 and 20 and the elastic units 30 are not biased transversely from the axis of the non-metal spring 10.

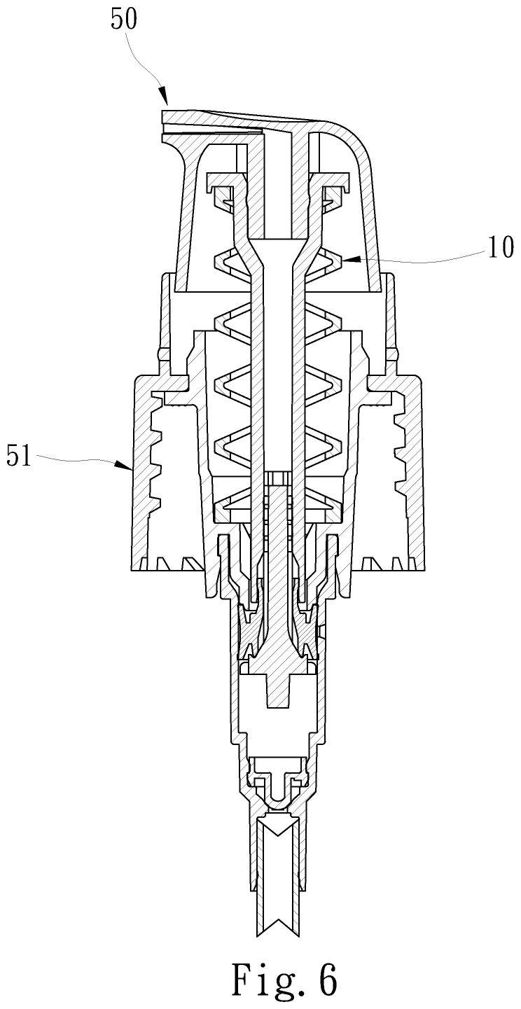

Referring to FIG. 6, the non-metal spring 10 recovers to return the button 50 to the original position relative to the threaded cup 51 when the button 50 is released from the pushing force. The non-metal spring 10, button 50 and the threaded cup 51 are ready for another round of operation.

The non-metal spring 10 can easily be recycled because it is made of only one material. Moreover, pollution related to production of a metal spring is prevented. Hence, the non-metal spring 10 is relatively friendly to the environment.

Preferably, the terminal rings 11 and 20 are identical to each other in shape and size, and the elastic units 30 are identical to one another in shape and size. Thus, the distance 41 is identical to the distance 44, and the elastic units 30 are made with the same height 45. The distance 42 is identical to the height 45.

However, in another embodiment, the terminal rings 11 and 20 can be different from each other in size, and the elastic units 30 can be different from one another in size. Thus, the distance 41 can be different from the distance 42, and the elastic units 30 are made of various heights.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A non-metal spring comprising:
two non-metal terminal rings; and
two non-metal intermediate rings formed between the non-metal terminal rings, wherein the non-metal intermediate rings intersect each other, thereby providing two cross portions.

2. The non-metal spring according to claim 1, wherein the cross portions divide each of the intermediate rings into a first portion and a second portion, wherein the first portion of each of the intermediate rings is connected to one of the terminal rings, and wherein the second portion of each of the intermediate rings is connected to a remaining one of the terminal rings.

3. The non-metal spring according to claim 2, wherein there is an obtuse angle between the upper portions of the intermediate rings, and wherein there is an acute angle between the first portion of one of the intermediate rings and the lower portion of a remaining one of the intermediate rings.

4. The non-metal spring according to claim 1, wherein each of the terminal rings is a circular ring.

5. The non-metal spring according to claim 1, wherein each of the intermediate rings is an oval ring.

6. A non-metal spring comprising:
two non-metal terminal rings; and
two non-metal elastic units connected to each another and formed between the non-metal terminal rings, wherein each of the non-metal elastic units comprises two non-metal intermediate rings intersecting each other, thereby providing two cross portions.

7. The non-metal spring according to claim 6, wherein the cross portions of each of the non-metal elastic units divide each of the intermediate rings into a first portion and a second portion, wherein the first portions of the intermediate rings of one of the non-metal elastic units are connected to one of the terminal rings, wherein the second portions of the intermediate rings of a remaining one of the non-metal elastic units are connected to a remaining one of the terminal rings, and wherein the second portions of the intermediate rings of one of the non-metal elastic units are connected to the first portions of the intermediate rings of a remaining one of the non-metal elastic units.

8. The non-metal spring according to claim 7, wherein there is an obtuse angle between the upper portions of the intermediate rings of each of the non-metal elastic units, and wherein there is an acute angle between the first portion of one of the intermediate rings and the lower portion of a remaining one of the intermediate rings in each of the non-metal elastic units.

9. The non-metal spring according to claim 6, wherein each of the terminal rings is a circular ring.

10. The non-metal spring according to claim 6, wherein each of the intermediate rings is an oval ring.

11. The non-metal spring according to claim 6, further comprising at least one non-metal elastic unit formed between the non-metal elastic units.
